(19) United States
(12) Patent Application Publication
(10) Pub. No.: US 2024/0176654 A1
(43) Pub. Date: May 30, 2024

(54) METHOD OF OPTIMIZING CALCULATION OF CONVOLUTIONAL LAYER AND CONVOLUTIONAL NEURAL NETWORK ACCELERATOR

(71) Applicant: POSTECH RESEARCH AND BUSINESS DEVELOPMENT FOUNDATION, Pohang-si (KR)

(72) Inventors: Youngjoo LEE, Pohang-si (KR); Hyeokjun KWON, Pohang-si (KR); Young-Seok KIM, Pohang-si (KR)

(73) Assignee: POSTECH RESEARCH AND BUSINESS DEVELOPMENT FOUNDATION, Pohang-si (KR)

(21) Appl. No.: 18/317,004

(22) Filed: May 12, 2023

(30) Foreign Application Priority Data
Nov. 25, 2022 (KR) 10-2022-0160902

(51) Int. Cl. G06F 9/48; G06F 5/01; G06F 7/50; G06F 7/523; G06F 7/544; G06F 9/50

(52) U.S. Cl. CPC G06F 9/4881; G06F 5/01; G06F 7/50; G06F 7/523; G06F 7/5443; G06F 9/5027

(57) ABSTRACT

Provided is a method of optimizing calculation of a convolutional layer including a plurality of channels and a convolutional neural network (CNN) accelerator. The method includes a classification operation of classifying weights of the plurality of channels as outlier (OL) elements and non-outlier (NOL) elements, a combination operation of combining two or more NOL elements which are put into calculation with the same activation value and present at the same slot in the plurality of channels, and a scheduling operation of moving a scheduling candidate element in a fetch window after the combination operation to a slot which is assigned no value.

### CROSS-REFERENCE TO RELATED APPLICATION

This application claims priority to and the benefit of Korean Patent Application No. 10-2022-0160902, filed on Nov. 25, 2022, the disclosure of which is incorporated herein by reference in its entirety.

### BACKGROUND

### 1. Field of the Invention

The present disclosure relates to a method of optimizing calculation of a convolutional layer and a convolutional neural network (CNN) accelerator.

### 2. Discussion of Related Art

Convolutional neural networks (CNNs), which are a kind of neural network, are machine learning networks specializing in extracting numerical features from data, such as images, voice, etc., using a matrix convolution operation and the like. Such a CNN has several layers including a convolutional layer which outputs calculation results of several channels using one input, and one layer includes several channels. Due to this characteristic, the CNN stores numerous weights which constitute channels to many layers, and performs repetitive calculations.

For the purpose of efficient calculation, optimization methods, such as data quantization, pruning, etc., are widely used to reduce the number of weights stored and the number of calculations. Quantization is for lowering the resolution of data expressions, which may effectively reduce the size of data to be calculated at the expense of degradation in data accuracy. Pruning is for reducing required storage space and skipping calculations that have little effect on a final calculation result by removing weights that have little effect on the final calculation result.

A sparse matrix is a data matrix mostly occupied by 0 due to the foregoing two techniques. Pieces of hardware for performing calculation with a matrix which is optimized by quantization and pruning for a size reduction use scheduling to increase hardware saturation and accelerate calculation due to pruning and data parallelization in which several pieces of data are simultaneously calculated in one cycle through calculators disposed in parallel.

CNNs to which both quantization and pruning are applied have appeared, but appropriate hardware accelerators for neural networks to which both quantization and pruning techniques are applied have not been so actively developed and the benefit of optimization is not maximized. In other words, existing hardware shows increased hardware saturation, but the effect of scheduling becomes negligible for sparse matrices.

### SUMMARY OF THE INVENTION

The present invention is directed to providing a technology for optimizing a neural network to which both quantization and pruning techniques are applied.

According to an aspect of the present invention, there is provided a method of optimizing calculation of a convolutional layer including a plurality of channels, the method including a classification operation of classifying weights of the plurality of channels as outlier (OL) elements and non-outlier (NOL) elements, a combination operation of combining two or more NOL elements which are put into calculation with and the same activation value and present at the same slot in the plurality of channels, and a scheduling operation of moving a scheduling candidate element in a fetch window after the combination operation to a slot which is assigned no value.

The OL elements and the NOL elements may all be expressed with binary numbers, and the number of bits expressing the OL elements may be n times the number of bits expressing the NOL elements (n: an integer of two or more).

The number of bits assigned to the slot may correspond to the number of bits of the OL elements.

In the combination operation, when the sum of the numbers of bits of the plurality of NOL elements combined in the same slot is larger than the number of bits assigned to the slot, a cycle may be added so that calculation of the NOL elements exceeding the number of bits assigned to the slot may be performed in a subsequent cycle.

In the combination operation, the NOL elements corresponding to the number of bits assigned to the slot may be combined in the slot.

The fetch window may include elements which are put into calculation with weights in j cycles subsequent to the same cycle (j: a natural number).

j may be 2.

In a subsequent cycle (an h^{th} cycle) to the same cycle, the scheduling candidate element may include elements included in slots present in a column (an i^{th} column) of the slot which is assigned no value, an (i−1)^{th} column, and an (i+1)^{th} column.

In an (h+1)^{th} cycle, the scheduling candidate element may further include elements included in slots present in the column (an i^{th} column) of the slot which is assigned no value, an (i−2)^{th} column, and an (i+2)^{th} column.

According to another aspect of the present invention, there is provided a convolutional neural network (CNN) accelerator including a plurality of processing elements, an activation buffer configured to store an activation value, and a weight buffer configured to store an NOL weight calculated by combining a plurality of channels. Each of the processing elements includes a multiplication unit configured to calculate a product of the activation value and the NOL weight, a multiplexing (MUX) unit configured to output an output of the multiplication unit to different accumulation units according to the combined channels, and an accumulation unit configured to accumulate the product according to each of the plurality of combined channels.

The multiplication unit may include a multiplier configured to receive the NOL weight and the activation value and calculate the product of the NOL weight and the activation value.

The multiplication unit may further include one or more multipliers, and each of the multiplier and the one or more multipliers may receive a part of an OL weight and the activation value and calculate a partial product of the OL weight and the activation value.

The multiplication unit may further include a shifter configured to shift the partial product to arrange digits of the partial product.

The MUX unit may include a plurality of unit MUX parts corresponding to the number of combined channels, each of the unit MUX parts may include a plurality of multiplexers to which the product of the multiplication unit, logic 0, and a selection signal are input, and the multiplexers may be controlled according to the selection signal and output the product of the multiplication unit.

The CNN accelerator may further include a plurality of multiplication units. The MUX unit may include a plurality of unit MUX parts corresponding to the number of combined channels, each of the unit MUX parts may include multiplexers to which a selection signal, logic 0, a part of a calculation result calculated by any one of the multiplication units, and a remaining part of the calculation result calculated by the multiplication units are all input, and the multiplexers may be controlled according to the selection signal and output the calculation results of the multiplication units.

The CNN accelerator may further include an activation register configured to store a value output by the activation buffer, a weight register configured to store a value output by the weight buffer, a multiplication unit register configured to store the output of the multiplication unit, and an accumulation unit register configured to store an output of the accumulation unit.

The activation register, the weight register, the multiplication unit register, and the accumulation unit register may operate in a pipeline manner.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a flowchart illustrating an overview of a method of optimizing calculation of a convolutional layer including a plurality of channels according to an exemplary embodiment;

FIG. 2 is a set of diagrams illustrating results of an operation of classifying a plurality of channels included in a convolutional layer;

FIG. 3 is a diagram illustrating a result of a combination operation;

FIG. 4 is a diagram illustrating a process of a scheduling operation;

FIG. 5 is a diagram illustrating a completed schedule;

FIG. 6 is a block diagram illustrating an overview of a neural network accelerator according to an exemplary embodiment;

FIG. 7 is a diagram illustrating an overview of a processing element according to a first exemplary embodiment;

FIG. 8 is a diagram illustrating an overview of a processing element according to a second exemplary embodiment;

FIG. 9 is a diagram illustrating an overview of a unit multiplexing (MUX) part including multiplexers;

FIG. 10 is a set of graphs for evaluating performance of an accelerator according to an exemplary embodiment using three types of convolutional neural networks (CNNs), VGG-16, ResNet-18, and MobileNetV2; and

FIG. 11 is a set of graphs illustrating energy efficiency of an accelerator according to an exemplary embodiment.

### DETAILED DESCRIPTION OF EXEMPLARY EMBODIMENTS

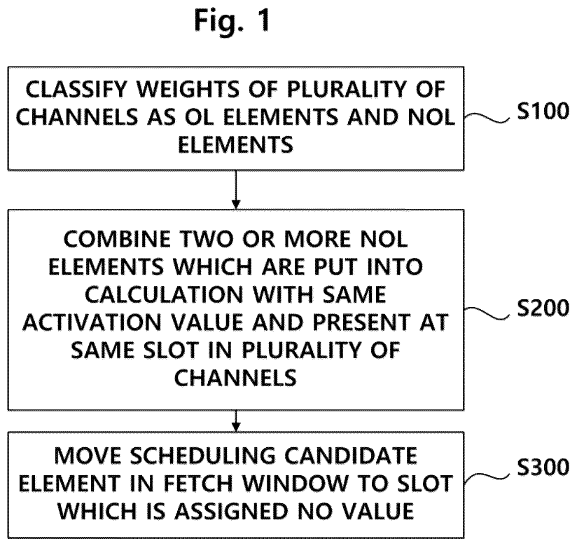

Hereinafter, exemplary embodiments will be described with reference to accompanying drawings. FIG. 1 is a flowchart illustrating an overview of a method of optimizing calculation of a convolutional layer including a plurality of channels according to an exemplary embodiment. Referring to FIG. 1, the optimization method includes a classification operation S100 of classifying weights of the plurality of channels as outlier (OL) elements and non-outlier (NOL) elements, a combination operation S200 of combining two or more NOL elements which are put into calculation with the same activation value and present at the same slot in the plurality of channels, and a scheduling operation S300 of moving a scheduling candidate element in a fetch window after the combination operation to a slot which is assigned no value.

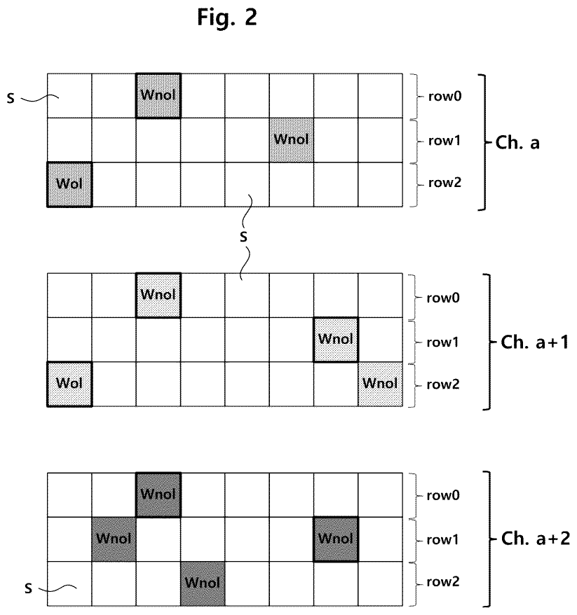

FIG. 2 is a set of diagrams illustrating results of the classification operation S100 for a plurality of channels included in a convolutional layer. Referring to FIGS. 1 and 2, when pruning for removing elements having a smaller weight than a predetermined threshold value and quantization for reducing a bit resolution of each element are performed, a majority of elements in each channel are removed, which results in a sparse matrix. When the sparse matrix is used without any change to perform calculation with an activation value, calculation speed and calculation efficiency are degraded.

In the embodiment, weight elements of each channel are classified as OL elements and NOL elements. For example, the number of bits expressing OL elements may be n times that expressing NOL elements (n: a natural number of two or more), and the number of bits of an OL element may correspond to the number of bits assigned to each slot S constituting a channel.

As an example, when the number of bits assigned to slots is 8, the number of bits of OL elements may be 8, and the number of bits of NOL elements may be 4. As another example, when the number of bits assigned to slots is 15, the number of bits of OL elements may be 15, and the number of bits of NOL elements may be 5.

In the classification results shown in the drawing, weights which are NOL elements expressible with a smaller number of bits than OL elements are indicated by Wnol, and weights which are OL elements expressible with a larger number of bits than NOL elements are indicated by Wol. Also, in the channels illustrated in FIG. 2, slots shown with thick lines represent that there is an element other than 0 at the same position in another channel.

In the exemplary embodiment illustrated in FIG. 2, each channel has three rows. However, this is just an embodiment, and each channel generally has three or more rows. Further, after the scheduling operation S300 is performed, each row and an activation value are put into calculation in the same cycle.

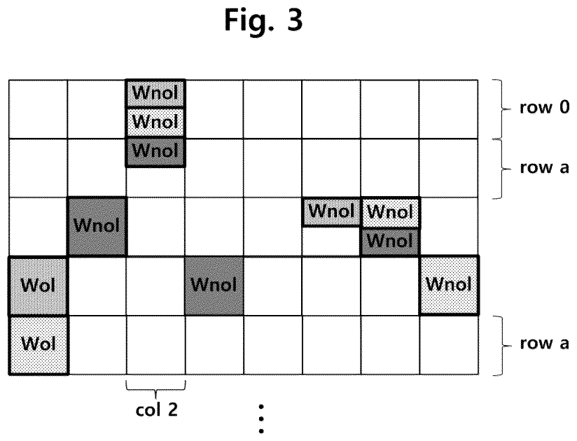

FIG. 3 is a diagram illustrating a result of the combination operation S200. Referring to FIG. 3, two or more NOL elements which are put into calculation with the same activation value and present at the same slot in a plurality channels are combined (S200). NOL elements at the same position in the channels are combined. FIG. 3 illustrates a case in which the number of bits assigned to slots S is 8, the number of bits of OL elements is 8, and the number of bits of NOL elements is 4. Accordingly, in the combination operation S200, a maximum of two NOL elements may be combined and disposed in one slot. Also, one OL element may be present in one slot.

At a slot of the zeroth row (row0) and the second column (col2) of a weight matrix generated in the combination operation S200, three Wnol elements are present and thus are not combined. Accordingly, one of the Wnol elements is disposed in the same column, that is, the second column (col2), and an additional row (row a).

Since elements included in the same row are put into calculation in the same cycle as weights, a cycle for calculation is added when a row is added. Accordingly, calculation speed may be reduced. However, it is possible to minimize the reduction in calculation speed by performing the scheduling operation S300 which will be described below, with the combination operation S200.

Likewise, all elements of the third row and the first column of channel a (Ch. a) and channel a+1 (Ch. a+1) are OL elements and are not disposed at the same slot in the combination operation S200. Accordingly, an additional row (row a) is formed, and any one element is disposed in the additional row (row a).

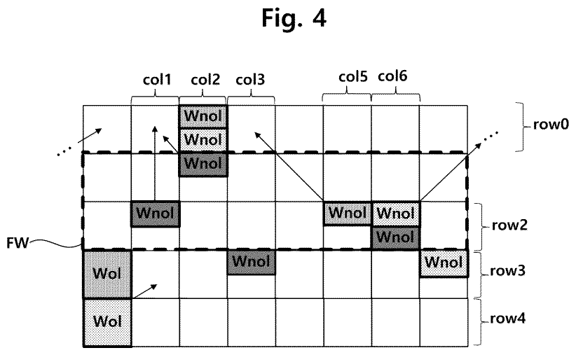

FIG. 4 is a diagram illustrating a process of the scheduling operation S300. Referring to FIG. 4, in the scheduling operation S300, scheduling is performed by moving scheduling candidate elements present in a fetch window FW. The density of a matrix may be increased through scheduling.

The size of the fetch window FW for scheduling may be designated by a user. With an increase in the number of rows included in the fetch window FW, the density of the matrix and calculation efficiency increase, but the load of scheduling on hardware also increases. Accordingly, an appropriate level of tradeoff is necessary, and in the illustrated embodiment, the fetch window FW is set to two rows row1 and row2 next to a row to be scheduled, row0.

In FIG. 4, routes in which scheduling candidate elements are moved are displayed with arrows. In the row next to row0 which is a row to be scheduled, scheduling candidate elements may be elements included in slots present in a column (an i^{th} column) of an empty slot which is assigned no value, an (i−1)^{th} column, and an (i+1)^{th} column. Also, in the second row after row0 which is a row to be scheduled, scheduling candidate elements may be elements included in slots present in a column (the i^{th} column) of an empty slot which is assigned no value, an (i−2)^{th} column, and an (i+2)^{th} column. In the case of calculating scheduling candidates, a calculated column number may exceed the number of columns. In this case, a scheduling candidate may be calculated by subtracting or adding the total number of columns from or to the calculated column number.

As illustrated in FIG. 4, a slot of row0 and col3 is assigned no value. Accordingly, Wnol, an NOL element of row2 and col5 which is a scheduling candidate element, may be scheduled and moved. A slot of row0 and col1 is assigned no value. Accordingly, Wnol, an NOL element of row2 and col1 which is a scheduling candidate element, may be scheduled and moved. Further, an element of row1 and col2 may also be scheduled and moved to row0 and col1. Accordingly, the two NOL weight elements may be combined and disposed at row0 and col1.

A slot of row0 and col0 is also assigned no value, and there is no scheduling candidate element in the same column or along diagonal lines within the fetch window FW. A slot of row2 and col6 may be moved in a diagonal direction to col8, but col8 exceeds the number of columns. Accordingly, when 8, the number of columns, is subtracted from the column number of col8, the Wnol elements present at row2 and col6 may be moved to row0 and col0 for scheduling. When all elements movable to row0 are moved in this way, there is no element in the fetch window FW. Therefore, when there is no element in a row, the row is deleted, no calculation is performed, and scheduling of the zeroth row is completed.

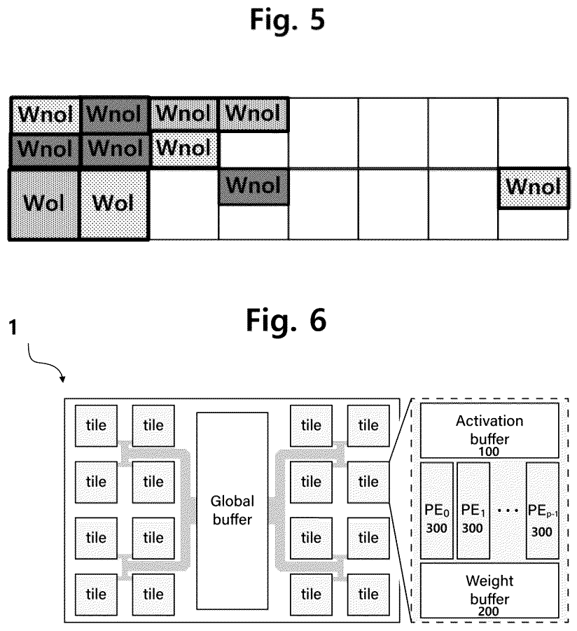

When scheduling of the zeroth row is completed, scheduling of the following third row row3 may be performed. A slot of row3 and col1 is assigned no value, and the Wol weight element present at row4 and col0 may be a scheduling candidate element. Accordingly, scheduling of the third row row3 is completed by moving the Wol weight element of row4 and col0 to row3 and col1 and deleting the fourth row row4 in the fetch window FW. The result is illustrated in FIG. 5.

According to an exemplary embodiment, the scheduling operation S300 is performed so that the number of elements of the same channel is not equal to or greater than half the number of slots in one row calculated in the same cycle. In the example illustrated in FIG. 5, each row has eight slots, and scheduling is performed so that no four of the slots are occupied by elements of the same channel (e.g., four OL elements and one NOL element of channel a). Such scheduling reduces critical delay as will be described in the following embodiment, and thus calculation speed can be increased.

The above embodiment has been described in the form of a method, and the method according to the exemplary embodiment may be implemented as a program executable by a machine. However, the above description does not exclude the method performed in an on-the-fly form in hardware with data which is input in real time.

According to the above exemplary embodiment, it is possible to achieve high density by performing a classification operation, a combination operation, and a scheduling operation on a plurality of channels having the form of a sparse matrix. In this way, high calculation speed and calculation efficiency can be obtained, and it is also possible to reduce power consumption.

A neural network accelerator according to an exemplary embodiment will be described below with reference to FIGS. 6 to 9. FIG. 6 is a block diagram illustrating an overview of a neural network accelerator according to an exemplary embodiment. Referring to FIG. 6, the neural network accelerator includes a global buffer which receives and stores weights and an activation value and provides the weights and activation value to a plurality of tiles, and the plurality of tiles which perform calculation with the weights and activation value provided by the global buffer.

Each tile includes a weight buffer 200 which stores a provided weight, an activation buffer 100 which stores the activation value, and a plurality of processing elements 300 which perform calculation with the weight provided by the weight buffer 200 and the activation value provided by the activation buffer 100.

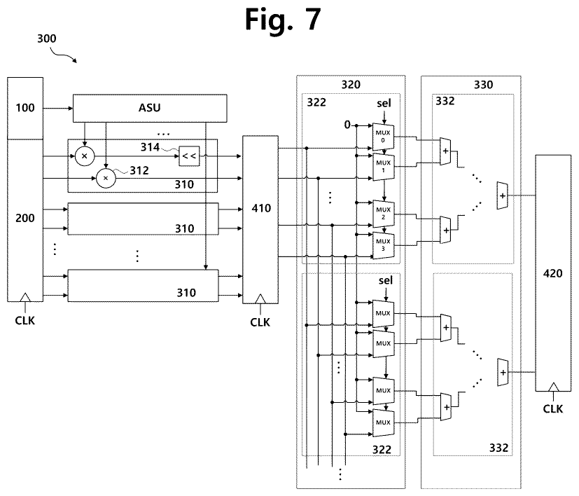

FIG. 7 is a diagram illustrating an overview of a processing element 300 according to a first exemplary embodiment. Referring to FIG. 7, the processing element 300 includes multiplication units 310 which calculate products of an activation value and NOL weights, a MUX unit 320 which outputs outputs of the multiplication units 310 to different unit accumulation parts 332 according to combined channels, and an accumulation unit 330 which accumulates the products according to each of the plurality of combined channels.

Data output from the weight buffer 200 to the multiplication units 310 may be two pieces of NOL weight data or one piece of OL weight data. When the number of bits of one piece of NOL weight data is Nw and the number of bits of one activation value is Na, the data output from the multiplication units 310 is two calculation results obtained by multiplying the two NOL weights by the activation value or an upper partial product and a lower partial product obtained by multiplying the OL weight by the activation value.

According to an exemplary embodiment, it is necessary to accumulate the calculation result of the OL weight and the activation value after bits constituting the lower partial product and the upper partial product are arranged according to digits. Accordingly, the upper partial product is shifted using a shifter 314 and output. Outputs of the multiplication units 310 are output to a multiplication register 410.

The MUX unit 320 includes a plurality of unit MUX parts 322, and each of the unit MUX parts 322 includes a plurality of multiplexers MUX. The number of unit MUX parts 322 may correspond to the number of channels included in a convolutional layer. Through the unit MUX parts 322, calculation results of the multiplication units 310 may be separated according to the channels and output to the unit accumulation parts 332.

Each unit MUX part 322 includes the plurality of multiplexers MUX, and “0” or a product of an NOL weight and the activation value calculated by the multiplication unit 310 is input to each of the multiplexers MUX. A channel selection signal sel is provided to each of the multiplexers MUX to control an output of the multiplexer MUX. For example, a product of the activation value and a weight of a predetermined channel is selected by the selection signal in the unit MUX part 322 and output, and when a value provided as an input to the multiplexer MUX does not correspond to the product of the activation value and the weight of the predetermined channel, the selection signal sel controls the multiplexer MUX so that “0” is output. In other words, the plurality of unit MUX parts 322 included in the MUX unit 320 receive the same product and output calculation results of only channels designated by channel selection signals sel.

As an example, it is assumed that a product of the activation value and an NOL weight of channel 0 is input to MUX0 included in the unit MUX part 322 and a product of the activation value and an NOL weight of channel 1 is input to MUX 1. Channel selection signals sel may be provided so that MUX0 outputs the product of the activation value and the NOL weight and MUX1 outputs 0.

As another example, it is assumed that an upper partial product of a product of the activation value and an OL weight of channel 0 is input to MUX0 included in the unit MUX part 322 and a lower partial product of the product of the activation value and the OL weight of channel 0 is input to MUX 1. The upper partial product is arranged by the shifter 314. Channel selection signals sel may be provided so that MUX0 outputs the upper partial product and MUX1 outputs the lower partial product.

A value output by each unit MUX part 322 is a result of multiplexing an activation value and a channel-specific weight together. The value is output to a unit accumulation part 332, accumulated, and provided to an accumulation register 420.

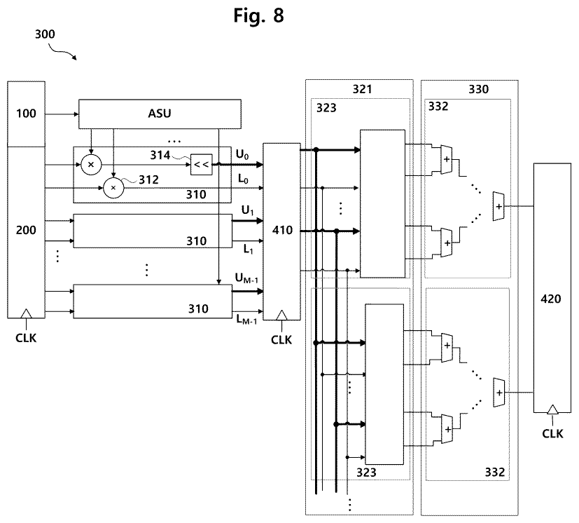

FIG. 8 is a diagram illustrating an overview of the processing element 300 according to a second exemplary embodiment. Description of elements which are identical or similar to those of the first exemplary embodiment described with reference to FIG. 7 will be omitted for simplicity. Referring to FIG. 8, the processing element 300 includes multiplication units 310 which calculate products of an activation value and NOL weights, a MUX unit 321 which outputs outputs of the multiplication units 310 to different unit accumulation parts 332 according to combined channels, and an accumulation unit 330 which accumulates the products according to each of the plurality of combined channels. The MUX unit 321 includes a plurality of unit MUX parts 323, and each of the unit MUX parts 323 includes a plurality of multiplexers MUX.

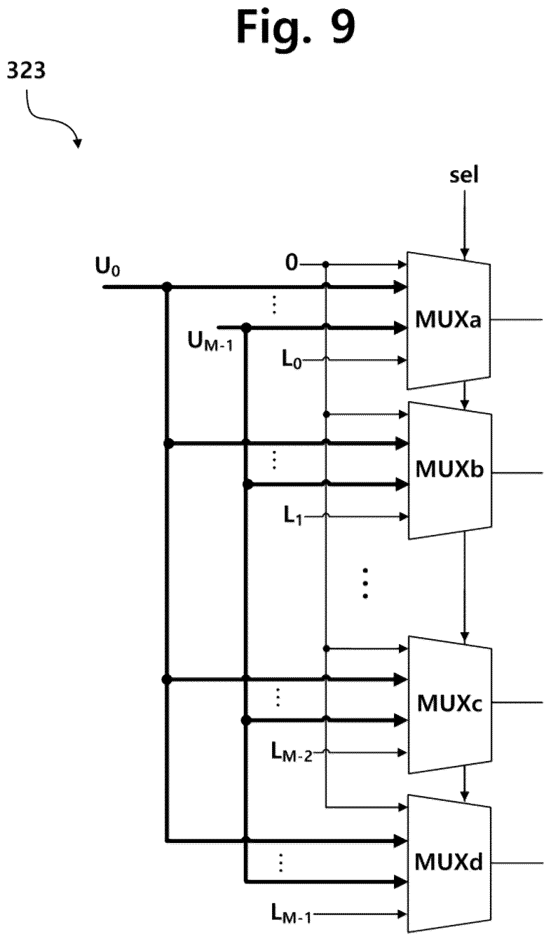

FIG. 9 is a diagram illustrating an overview of a unit MUX part 323 including multiplexers. Referring to FIGS. 8 and 9, each unit MUX part 323 includes M+2 multiplexers MUX. M is a natural number corresponding to the number of multiplication units 310 illustrated in FIG. 8 and corresponds to the number of slots which are illustrated in FIG. 5 and calculable in one cycle.

M upper calculation results U₀, U₁, . . . , and U_{M-1} output by the multiplication units 310, one lower calculation result L, and 0 are input to multiplexers MUXa, MUXb, MUXc, and MUXd included in each unit MUX part 323. Each input of a multiplexer is controlled by a channel selection signal sel so that the multiplexer outputs any one of the inputs.

For example, it is assumed that a unit MUX part 323 is required to output a calculation result between an OL weight of channel 1 and an activation value. When an upper partial product of the OL weight of channel 1 and the activation value is output as U₁ and a lower partial product of the OL weight of channel 1 and the activation value is output as L₁, a selection signal sel is provided to the multiplexer MUXb so that the multiplexer MUXb outputs the lower partial product L₁. A selection signal sel is provided to the multiplexer MUXa which is one of other multiplexers included in the unit MUX part 323 so that the multiplexer MUXa outputs the upper partial product U₁. Accordingly, the unit MUX part 323 outputs the upper partial product and the lower partial product to a following accumulator, and the accumulator may calculate a partial sum of the corresponding channel by accumulating the partial products. A selection signal may be provided to multiplexers to which an input of another channel which is not designated is provided so that the multiplexers output 0.

As described in the above embodiment, the number of unit MUX parts 323 included in the MUX unit 320 may correspond to the number of channels included in the convolutional layer, and through the unit MUX parts 323, calculation results of the multiplication units 310 may be separated according to channels and output to the unit accumulation parts 332.

As described above, scheduling is performed so that the number of elements of any one channel is not equal to or greater than half the number of slots calculated in the same cycle. Accordingly, an accelerator according to the exemplary embodiment illustrated in FIGS. 8 and 9 can operate without difficulty.

Further, in comparison with the related art which requires 2M inputs in total, it is possible to halve the number of inputs to M. Accordingly, hardware complexity can be reduced, and calculation speed can be increased therefrom.

In addition, since the activation buffer 100, the weight buffer 200, and the multiplication registers 410 and the accumulation registers 420 in the processing elements 300 according to the exemplary embodiment operate in a pipeline manner, it is possible to obtain high throughput.

### Experimental Example and Simulation

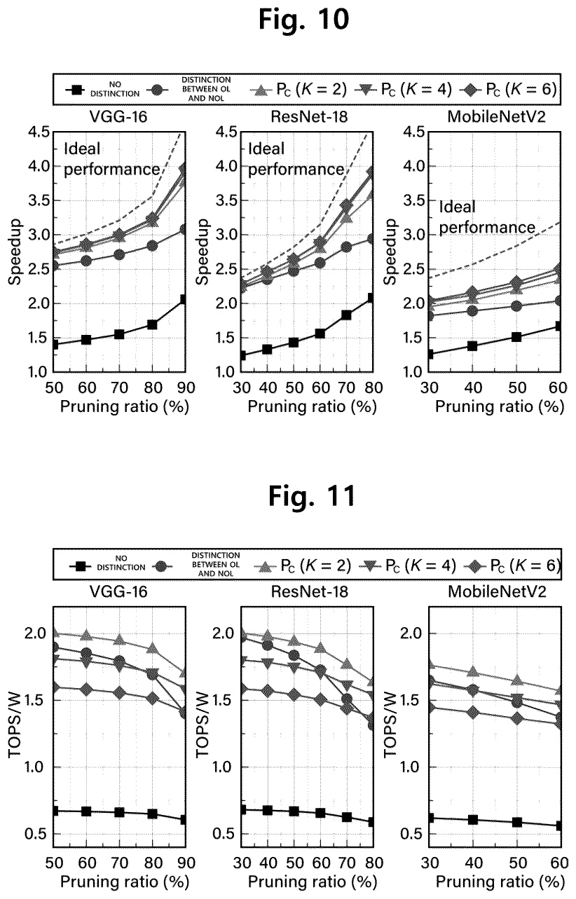

FIG. 10 is a set of graphs for evaluating performance of an accelerator according to an exemplary embodiment using three types of convolutional neural networks (CNNs), VGG-16, ResNet-18, and MobileNetV2. A black square represents a case in which OL weights and NOL weights are not distinguished, and a blue circle represents a case in which scheduling is performed with OL weights and NOL weights distinguished. A purple triangle, a red downward-pointing triangle, and a green diamond represent cases in which two channels are combined, four channels are combined, and six channels are combined according to the exemplary embodiment, respectively.

As shown in FIG. 10, an improvement in the performance of the exemplary embodiment with an increase in the degree of sparseness of a matrix (a pruning ratio) is similar to an ideal performance improvement compared to that of the related art.

FIG. 11 is a set of graphs illustrating energy efficiency of an accelerator according to an exemplary embodiment and shows how many operations are performed per unit power. Like in FIG. 10, performance was evaluated using the three types of CNNs, VGG-16, ResNet-18, and MobileNetV2. A black square represents a case in which no scheduling is performed, and a blue circle represents a case in which scheduling is performed according to the related art. A purple triangle, a red downward-pointing triangle, and a green diamond represent cases in which two channels are combined, four channels are combined, and six channels are combined according to the exemplary embodiment, respectively.

In a section with a low pruning ratio, the related art and the proposed technology show similar performance, but with an increase in the pruning ratio, the proposed technology shows higher energy efficiency than the related art.

Exemplary embodiments of the present invention provide a calculation optimization method for a neural network accelerator to operate calculation-efficiently and energy-efficiently and a neural network accelerator operating according to the calculation optimization method.

The present invention has been described with reference to exemplary embodiments illustrated in the drawings to help others understand the present invention. However, the exemplary embodiments are for the purpose of implementation and only illustrative. Those of ordinary skill in the art will appreciate that various modifications and equivalents can be made from the embodiments. Therefore, the technical scope of the present invention should be defined by the appended claims.

What is claimed is:

1. A method of optimizing calculation of a convolutional layer including a plurality of channels, the method comprising:
a classification operation of classifying weights of the plurality of channels as outlier (OL) elements and non-outlier (NOL) elements;
a combination operation of combining two or more NOL elements which are put into calculation with the same activation value and present at the same slot in the plurality of channels; and
a scheduling operation of moving a scheduling candidate element in a fetch window after the combination operation to a slot which is assigned no value.

2. The method of claim 1, wherein the OL elements and the NOL elements are all expressible with binary numbers, and
a number of bits expressing the OL elements is n times a number of bits expressing the NOL elements (n: an integer of two or more).

3. The method of claim 2, wherein a number of bits assigned to the slot corresponds to the number of bits of the OL elements.

4. The method of claim 1, wherein the combination operation comprises, when a sum of numbers of bits of the plurality of NOL elements combined in the same slot is larger than a number of bits assigned to the slot, adding a cycle so that calculation of the NOL elements exceeding the number of bits assigned to the slot is performed in a subsequent cycle.

5. The method of claim 4, wherein the combination operation comprises combining the NOL elements corresponding to the number of bits assigned to the slot in the slot.

6. The method of claim 1, wherein the fetch window includes elements which are put into calculation with weights in j cycles subsequent to the same cycle (j: a natural number).

7. The method of claim 6, wherein j is 2.

8. The method of claim 1, wherein, in a subsequent cycle (an h^{th} cycle) to the same cycle, the scheduling candidate element include elements included in slots present in a column (an i^{th} column) of the slot which is assigned no value, an (i−1)^{th} column, and an (i+1)^{th} column.

9. The method of claim 8, wherein, in an (h+1)^{th} cycle, the scheduling candidate element further include elements included in slots present in the column (an i^{th} column) of the slot which is assigned no value, an (i−2)^{th} column, and an (i+2)^{th} column.

10. A convolutional neural network (CNN) accelerator comprising:
a plurality of processing elements;
an activation buffer configured to store an activation value; and
a weight buffer configured to store a non-outlier (NOL) weight calculated by combining a plurality of channels,
wherein each of the processing elements comprises:
a multiplication unit configured to calculate a product of the activation value and the NOL weight;
a multiplexing (MUX) unit configured to output an output of the multiplication unit to different accumulation units according to the combined channels; and
an accumulation unit configured to accumulate the product according to each of the plurality of combined channels.

11. The CNN accelerator of claim 10, wherein the multiplication unit includes a multiplier configured to receive the NOL weight and the activation value and calculate the product of the NOL weight and the activation value.

12. The CNN accelerator of claim 11, wherein the multiplication unit further includes one or more multipliers, and
each of the multiplier and the one or more multipliers receives a part of an OL weight and the activation value and calculates a partial product of the OL weight and the activation value.

13. The CNN accelerator of claim 12, wherein the multiplication unit further includes a shifter configured to shift the partial product to arrange digits of the partial product.

14. The CNN accelerator of claim 10, wherein the MUX unit includes a plurality of unit MUX parts corresponding to a number of combined channels,
each of the unit MUX parts includes a plurality of multiplexers to which the product of the multiplication unit, logic 0, and a selection signal are input, and
the multiplexers are controlled according to the selection signal and output the product of the multiplication unit.

15. The CNN accelerator of claim 10, further comprising a plurality of multiplication units,
wherein the MUX unit includes a plurality of unit MUX parts corresponding to a number of combined channels,
each of the unit MUX parts includes multiplexers to which a selection signal, logic 0, a part of a calculation result calculated by any one of the multiplication units, and a remaining part of the calculation result calculated by the multiplication units are all input, and
the multiplexers are controlled according to the selection signal and output the calculation result of the multiplication units.

16. The CNN accelerator of claim 10, further comprising:
an activation register configured to store a value output by the activation buffer;
a weight register configured to store a value output by the weight buffer;
a multiplication unit register configured to store the output of the multiplication unit, and
an accumulation unit register configured to store an output of the accumulation unit.

17. The CNN accelerator of claim 16, wherein the activation register, the weight register, the multiplication unit register, and the accumulation unit register operate in a pipeline manner.
